(19) United States
(12) Patent Application Publication
(10) Pub. No.: US 2015/0272816 A1
(43) Pub. Date: Oct. 1, 2015

(54) SMART MATTRESS

(71) Applicant: ZHEJIANG XINYI INTELLIGENT DRIVE TECHNOLOGY CO., LTD., Shangyu City (CN)

(72) Inventors: Zhigang Zhang, Shangyu City (CN); Zhongdi Qian, Shangyu City (CN); Miaoqing Qin, Shangyu City (CN); Jianxing Xuan, Shangyu City (CN); Yanyan Wang, Shangyu City (CN)

(73) Assignee: ZHEJIANG XINYI INTELLIGENT DRIVE TECHNOLOGY CO., LTD., Shangyu City (CN)

(21) Appl. No.: 14/007,621

(22) PCT Filed: Nov. 29, 2012
(86) PCT No.: PCT/CN2012/085495

§ 371 Date: Dec. 25, 2013

(30) Foreign Application Priority Data
Jul. 31, 2012 (CN) 201210269347.7

(51) Int. Cl. A61H 23/02; A61H 15/00; A47C 20/04

(52) U.S. Cl. CPC A61H 23/02; A47C 20/041; A61H 15/00; A61H 2015/0028

(57) ABSTRACT

A smart mattress includes a mattress base, a bed assembly, a massage module and a wireless control system. The mattress base includes a mattress frame. The bed assembly is mounted on the mattress frame. The bed assembly comprises a multi-section bed board, a stuff layer and a latex layer from bottom to top. The bed assembly and the mattress base are wrapped with a knitted fabric. The massage module is embedded in the bottom of the stuffer layer and connected with corresponding function interfaces of the wireless control system. The massage module includes a shoulder and neck rolling massage unit, a waist rolling massage unit and a leg vibration massage unit. The smart mattress of the present invention can adjust the angle of the head and leg as desired and has a massage function.

### BACKGROUND OF THE INVENTION

1. Field of the Invention

The present invention relates to a smart mattress, and more particularly to a smart mattress which can adjust the angle of the head and leg as desired and has a massage function.

2. Description of the Prior Art

With development of the living standard, more and more people start to pay attention to the quality of life. Sleeping occupies one-third of one's lifetime. Therefore, the demand for the bed becomes increasingly high and diverse. The development trend of the existing beds is multi-function.

The existing electric beds on the market can adjust the angle of the bed and ascend and descend. However, the adjustment is achieved through the bed frame and most of the beds are soft. This cannot satisfy different users. The bed is heavy. It is inconvenient for replacement. The mattress and the bed frame must be replaced entirely to cause unnecessary pollution and waste and influence the aesthetics of the bedroom.

An improved mattress on the market can adjust its height and has a massage function. But, it can only adjust the height of the head and the mattress is thick. It is unable to mate with a domestic bed optionally, and it is against the ultra-thin demand. Besides, the massage devices can be classified according to their control ways, such as a fixed type, a pneumatic type or a hydraulic type. They are passive. The massage operation of this mattress is troublesome and the function is single. The normal sleeping function is weakened. Therefore, a person skilled in the art is eager to research and develop a smart mattress which can be operated simply and is convenient for use and has a lower price and provides lift and massage functions. Accordingly, the inventor of the present invention has devoted himself based on his many years of practical experiences to solve this problem.

### SUMMARY OF THE INVENTION

The primary object of the present invention is to provide a smart mattress which can ascend and descend and provide a massage function. The head and tail of the smart mattress can ascended and descend. The massage module is arranged according to the body's shape. It is simple for operation and convenient for use and applied to various bed frames.

In order to achieve the aforesaid object, the smart mattress of the present invention comprises a mattress base, a bed assembly, a massage module and a wireless control system. The mattress base comprises a mattress frame. The bed assembly is mounted on the mattress frame. The bed assembly comprises a multi-section bed board, a stuff layer and a latex layer from bottom to top. The bed assembly and the mattress base are wrapped with a knitted fabric. The massage module is embedded in the bottom of the stuffer layer and connected with corresponding function interfaces of the wireless control system.

Preferably, the massage module comprises a shoulder and neck rolling massage unit, a waist rolling massage unit and a leg vibration massage unit.

Preferably, the mattress frame comprises a transmission shaft therein. Two ends of the transmission shaft are movably connected with the mattress frame. The middle portion of the transmission shaft is fixedly connected with a support arm. The distal end of the support arm is connected with a pulley. When in motion, the pulley contacts the multi-section bed board. The wireless control system comprises a wireless control device and an electric linear driving device controlled by the wireless control device. The electric linear driving device is inserted on the transmission shaft through transmission shaft engaging troughs formed at two ends of the electric linear driving device. The electric linear driving device comprises an electric linear driver. The electric linear driver comprises a push block therein. The transmission shaft is connected with a swing arm. The swing arm is contact with the push block.

Preferably, the transmission shaft comprises a head transmission shaft and a leg transmission shaft. The head transmission shaft and the leg transmission shaft are parallel to each other.

Preferably, the multi-section bed board is a wooden board comprising A section, B section, C section, D section and E section which are hingedly connected with one another. Two parallel first iron plates are provided between the head transmission shaft and the leg transmission shaft. Two ends of each first iron plate are fixed to the mattress frame. Each first iron plate has two connecting holes for connection of the C section of the multi-section bed board. The tail portion of the mattress frame is provided with a second iron plate which is parallel to the first iron plates. A pair of third iron plates is provided in front of the second iron plate. One end of each third iron plate is fixed to the mattress frame with a screw. A gap is formed among each third iron plate, the screw and the mattress frame. Two ends of the second iron plate are respectively connected with the pair of third iron plates. The second iron plate has two connecting holes for connection of the E section of the multi-section bed board.

Preferably, the electric linear driving device further comprises a control box. The massage module is connected with corresponding interfaces on the control box. The electric linear driver is connected with the corresponding interfaces on the control box.

Preferably, the stuff layer is one of a spring chip layer, a palm chip layer and a sponge chip layer or a combination thereof.

Preferably, the mattress frame has four legs at a lower end thereof. The outer side of the mattress frame is provided with a wooden frame.

Preferably, the mattress base is further provided with four detachable support legs. The four detachable support legs are respectively provided with bolts for threadedly connecting the legs of the mattress frame.

Preferably, the control box and two electric linear drivers are separately installed. The middle portion of the mattress frame is provided with a head driver fixing shaft and a leg driver fixing shaft. The tail portion of each electric linear driver is engaged on a driver fixing shaft and fixed with a nut and a screw. The head of each electric linear driver has a through hole. A pin is provided to insert through the through hole of the head of each electric linear driver and the through hole of the swing arm and locked with a lock member. The control box is fixedly installed underneath the E section of the multi-section bed board.

The advantages of the present invention are as follows:

1. The smart mattress of the present invention can ascend and descend the head and the leg. The shoulder and neck rolling massage unit and the waist rolling massage unit are able to adjust their massage strength. The lift and massage function can be integrated. Each function can be controlled separately according to the demand to satisfy different users.

2. When the lift function and the massage function are not required, the lift device and the massage device are hidden in the mattress like a normal mattress. The smart mattress can be applied to various beds optionally, without replacement of the entire bed. It can save the cost and keep the aesthetics of the bedroom.

3. The smart mattress of the present invention is ultra-thin.

4. The lift and massage functions of the smart mattress of the present invention are controlled in a wireless way, like operation of household appliances. The operation is simple and the price is low and it is convenient for use.

### BRIEF DESCRIPTION OF THE DRAWINGS

FIG. 1 is an exploded view according to a preferred embodiment of the present invention;

FIG. 2 is another exploded view according to the preferred embodiment of the present invention;

FIG. 3 is a partial view showing the mattress frame of FIG. 1;

FIG. 4 is a partial view showing the transmission shaft of FIG. 1;

FIG. 5 is a partial view showing the electric linear control device of FIG. 1;

FIG. 6 is a partial view showing the support arm of FIG. 1;

FIG. 7 is a partial view showing the mattress frame of FIG. 2;

FIG. 8 is a schematic view showing connection of the transmission shaft and the tail of the electric linear control device of FIG. 2;

FIG. 9 is a schematic view showing connection of the electric linear driver and the swing arm of FIG. 2;

FIG. 10 is an exploded view showing the shoulder and neck rolling massage unit and the waist rolling massage unit;

FIG. 11 is a partial view showing the lift mechanism and the limit mechanism of the shoulder and neck rolling massage unit and the waist rolling massage unit; and

FIG. 12 is a partial view showing the lift motor of the shoulder and neck rolling massage unit and the waist rolling massage unit.

### DETAILED DESCRIPTION OF THE PREFERRED EMBODIMENTS

Embodiments of the present invention will now be described, by way of example only, with reference to the accompanying drawings.

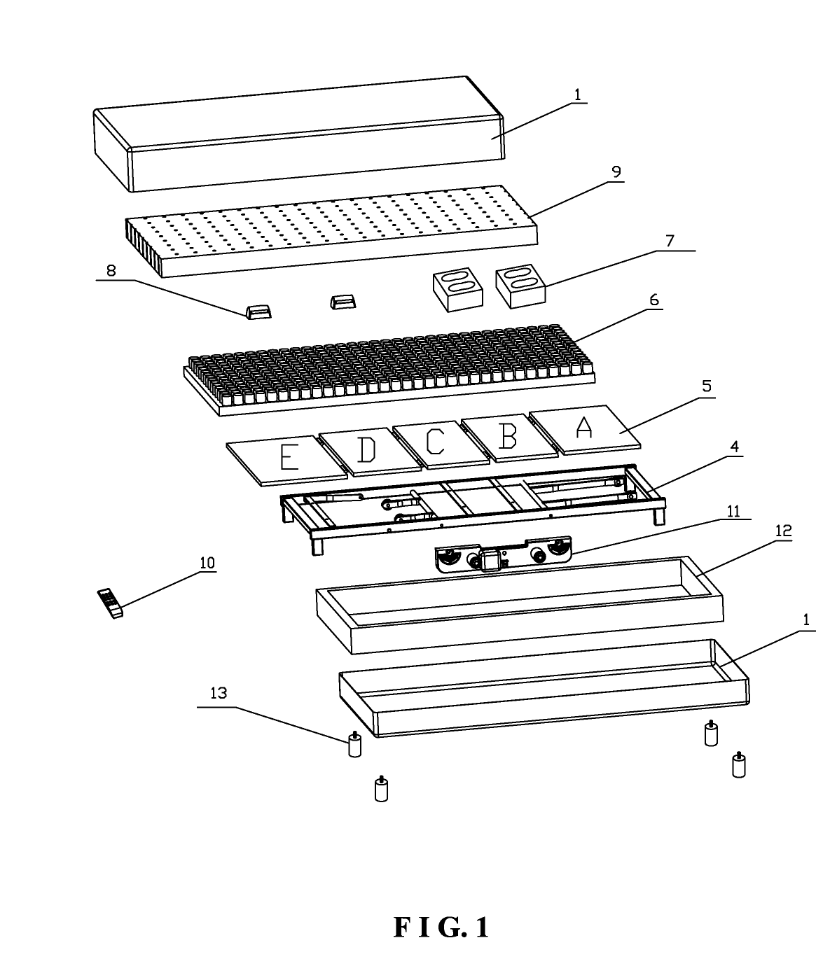

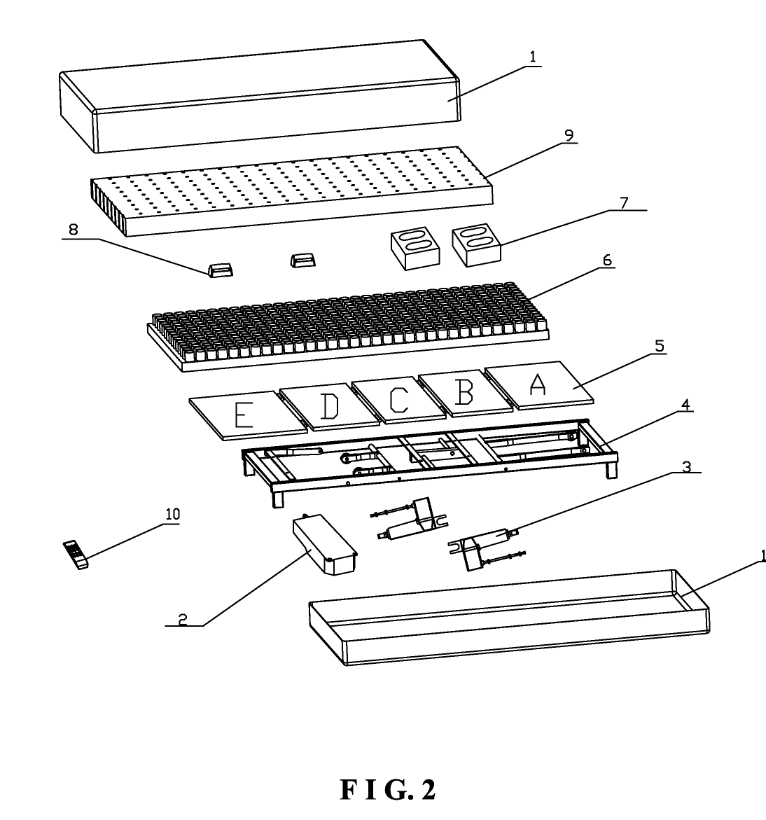

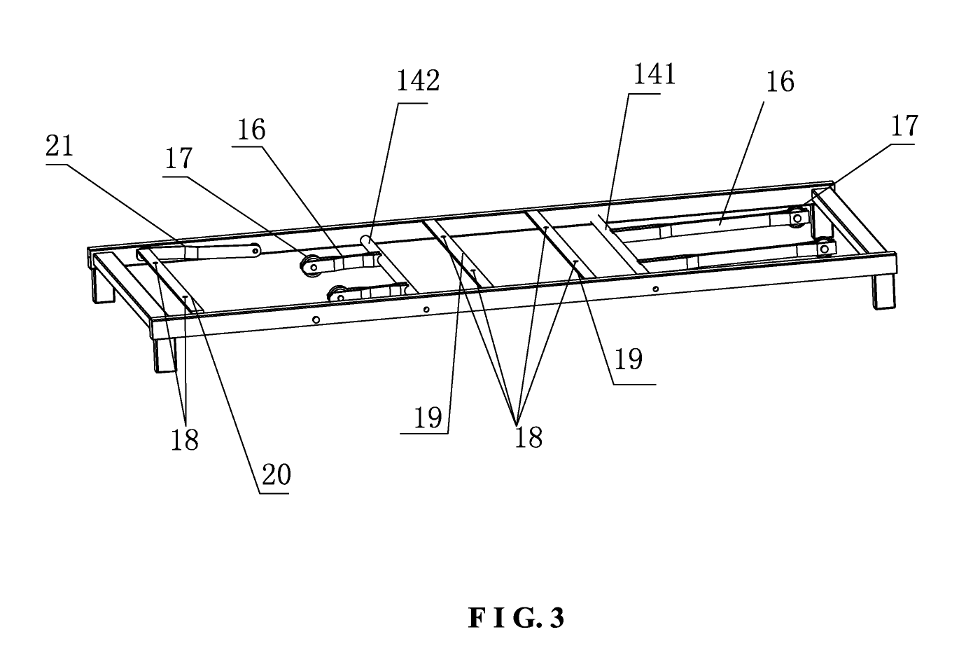

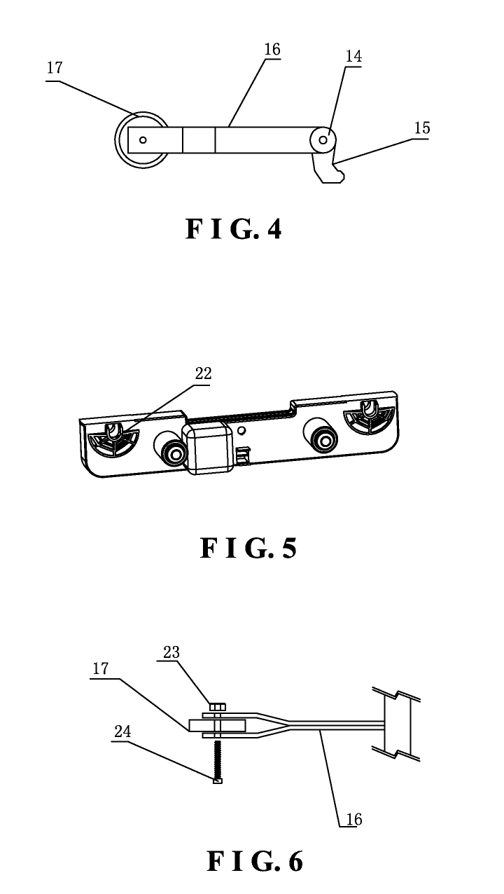

As shown in FIG. 1 and FIG. 3 to FIG. 6, the smart mattress according to a preferred embodiment of the present invention comprises a mattress base, a bed assembly, a massage module and a wireless control system. The mattress base comprises a mattress frame 4. The bed assembly is mounted on the mattress frame 4. The bed assembly comprises a multi-section bed board 5, a stuff layer 6 and a latex layer 9 from bottom to top. The multi-section bed board 5 and the stuff layer 6 are fixed in a bonding way. The stuff layer 6 and the latex layer 9 are fixed in a bonding way. The bed assembly and the mattress base are wrapped with a knitted fabric. The massage module is embedded in the bottom of the stuffer layer. The stuff layer 6 is cut to form an installation layer corresponding in position and in shape to the massage module. The massage module is embedded in the installation layer and connected with the corresponding function interface of the wireless control system.

The massage module comprises a shoulder and neck rolling massage unit 7, a waist rolling massage unit 7 and a leg vibration massage unit 8.

The leg vibration massage unit 8 is a normal massage unit and won't be described in detail.

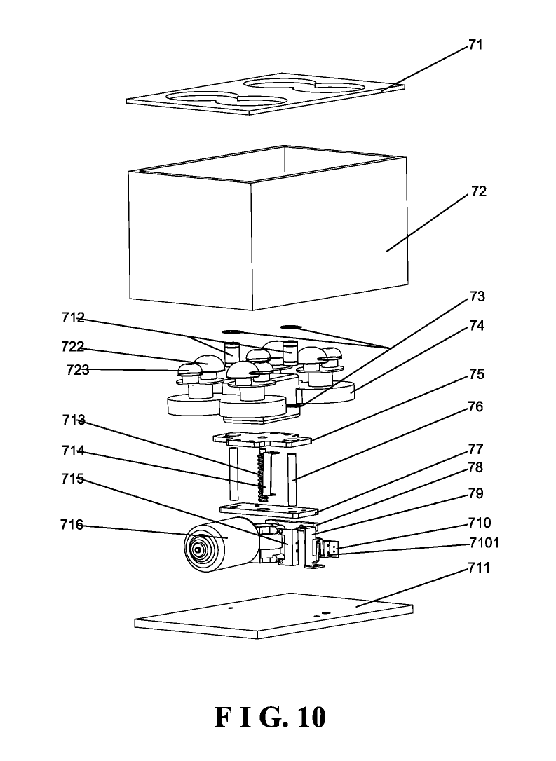

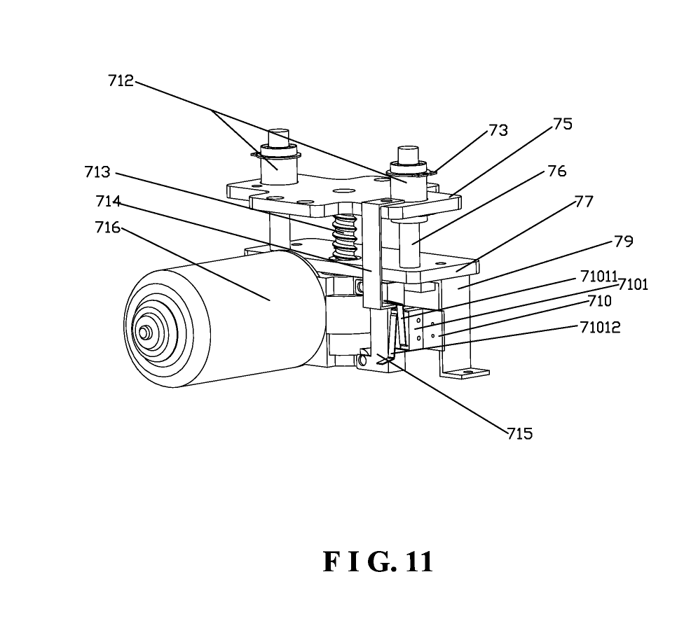

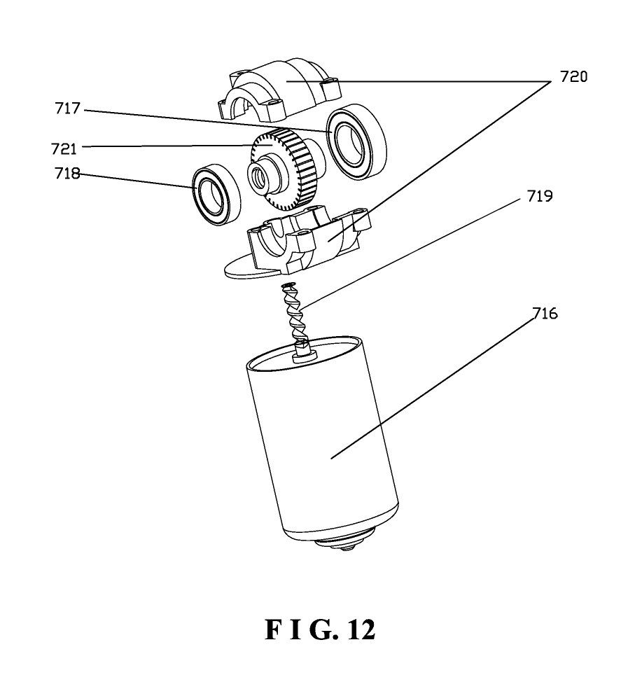

As shown in FIG. 10 to FIG. 12, the shoulder and neck rolling massage unit 7 and the waist rolling massage unit 7 are able to adjust their massage strength, and comprise a lift mechanism, a route limit mechanism and a massage head 74. The route limit mechanism and the lift mechanism are fixedly connected. The massage head 74 is installed at the upper part of the lift mechanism.

The lift mechanism comprises a lift motor 716, a lift motor lower installation board 77, a guide pole 76, a bolt 713, a linear bearing 712 and a massage head installation board 711. The upper surface of the lift motor lower installation board 77 is fixedly connected with the guide pole 76, and the lower surface of the lift motor lower installation board 77 is fixedly connected with an aluminum support 720 at the tail of the lift motor 716. The middle of the lift motor lower installation board 77 has a through hole. A turbine 721 is installed inside the aluminum support 720. The linear bearing 712 is installed on the upper surface of the massage head installation board 75. The guide pole 76 is inserted through the linear bearing 712. The bolt 713 is fixed to the lower surface of the massage head installation board 75. The other end of the bolt 713 passes through the through hole and is inserted in the turbine 712.

The route limit mechanism comprises a route switch 710, a route switch installation board 715 and a route probe 714. The route switch 710 is fixed on the aluminum support 720 through the route switch installation board 715. The route switch 710 comprises a microswitch 7101 and an upper micro contact plate 71011 and a lower micro contact plate 71012. The upper micro contact plate 71011 and the lower micro contact plate 71012 are disposed on the microswitch 7101. One end of the upper micro contact plate 71011 is fixed to the upper end of the microswitch 7101, and the other end is bent. One end of the lower micro contact plate 71012 is fixed to the lower end of the microswitch 7101, and the other end is bent. The upper end of the route probe 714 is fixed on the massage head installation board 75, and the lower end is bent. The bent portion of the route probe 714 is located between the bent portion of the upper micro contact plate 71011 and the bent portion of the lower micro contact plate 71012.

The massage head 74 is a normal rolling massage head on the market and the lift motor 716 is a normal lift motor so they won't be described hereinafter.

The middle of the lift motor 716 is provided with a worm 719. The worm 719 has teeth thereon to mesh with the outer teeth of the turbine 721. The turbine 721 has inner threads to mesh with the threads on the bolt 713.

The aluminum support 720 comprises an upper cover and a lower cover. Two sides of the turbine 719 are installed with a big bearing 717 and a small bearing 718, respectively. The big bearing 717 and the small bearing 718 hold the turbine 721 to be installed on the upper cover of the aluminum support 720. The upper cover is connected with the lower cover through screws.

The massage device further comprises a casing to cover the whole massage device.

The casing comprises an installation bottom board 711, a wood outer frame 72 and a support top board 71. The lift mechanism further comprises two fixing feet 79. The upper ends of the fixing feet 79 are fixedly connected to the lift motor lower installation board 77, and the lower ends of the fixing feet 79 are fixedly connected to the installation bottom board 711. The whole massage device is fixed on the installation bottom board 711. The wood outer frame 72 is to cover the whole massage device. The bottom of the wood outer frame 72 is connected to the installation bottom board 711 with screws, and the top of the wood outer frame 72 is connected to the support top board 71 with screws. The support top board 71 has an opening corresponding in shape to the massage head 74. The massage head comprises a large massage sphere 722 and a small massage sphere 723. The small massage sphere 723 is located at the inner side of the opening, and the large massage sphere 722 is located on the same plane as the opening.

The lift mechanism further comprises a motor fixing block 78. The motor fixing block 78 is a rectangular metallic block. Two sides of the motor fixing block 78 has through holes at different distances for fixing the lift motor lower installation board 77 and the aluminum support 720 respectively through screws.

Two sides of the massage head installation board 75 have holes. The linear bearings 712 are embedded in the holes. Two ends are engaged through engaging reeds 73 to prevent the linear bearings 712 from disengagement.

The massage head 74 is fixed on the massage head installation board 75.

When in work, the lift motor 716 is connected with external voltage and the rotor of the lift motor 716 works. The worm 719 brings the turbine 721 to work through engagement of the gear wheel. The worm 721 and bolt 713 convert the circular motion into the linear motion through threads to bring movement of the massage head installation board 75. The linear bearing 712 confines the massage head installation board 75 to move up and down through the guide pole. When in work, both the large massage sphere 722 and the small massage sphere 723 are at the upper part of the support top board 1. When the route probe 714 reaches the upper/lower route limit to touch the upper micro contact plate 71011 or the lower micro contact plate 71012 so that the micro switch has a short circuit, the lift motor 716 will be disconnected from the external voltage and the lift motor 716 has a short circuit between anode and cathode of the power code to be self-locking.

The rolling massage unit can ascend and descend, and the massage strength is adjustable by adjusting the height of the massage head.

The mattress frame 4 comprises a transmission shaft 14 therein. Two ends of the transmission shaft 14 are movably connected with the mattress frame 4. The middle portion of the transmission shaft 14 is fixedly connected with a support arm 16. The distal end of the support arm 16 is connected with a pulley 17. When in motion, the pulley 17 contacts the multi-section bed board 5. The wireless control system comprises a wireless control device 10 and an electric linear driving device 11 controlled by the wireless control device 10. Two ends of the electric linear driving device 11 are formed with transmission shaft engaging troughs 22. The electric linear driving device 11 is placed on the transmission shaft 14 through the transmission shaft engaging troughs 22. The electric linear driving device 11 comprises an electric linear driver 3. The electric linear driver 3 comprises a push block (not shown in the drawings) therein. The transmission shaft 14 is connected with a swing arm 15. The swing arm 15 is contact with the push block.

The transmission shaft 14 further comprises a head transmission shaft 141 and a leg transmission shaft 142. The head transmission shaft 141 and the leg transmission shaft 142 are parallel to each other.

The multi-section bed board 5 is a wooden board comprising A section, B section, C section, D section and E section. The sections are hingedly connected with one another. Two parallel first iron plates 19 are provided between the head transmission shaft 141 and the leg transmission shaft 142. Two ends of each first iron plate 19 are fixed to the mattress frame 4. Each first iron plate 19 has two connecting holes 18 for connection of the C section of the multi-section bed board 5. The tail portion of the mattress frame 4 is provided with a second iron plate 20 which is parallel to the first iron plates 19. A pair of third iron plates 21 is provided in front of the second iron plate 20. The pair of third iron plates 21 is fixed to the mattress frame 4 with screws 24. A gap is formed among the third iron plate 21, the screw 24 and the mattress frame 4. Two ends of the second iron plate 20 are respectively connected with the pair of third iron plates 21. The second iron plate 20 has two connecting holes 18 for connection of the E section of the multi-section bed board 5.

The electric linear driving device 11 further comprises a control box 2. The massage module is connected with the corresponding interfaces on the control box 2. The electric linear driver 3 is connected with the corresponding interfaces on the control box 2.

The stuff layer 6 is selective according to the demand of the user, which can be a spring chip layer, a palm chip layer, a sponge chip layer or a combination thereof. If the stuff layer 6 is a soft layer, like a sponge chip layer or the like, the whole sponge chip layer is installed on the multi-section bed board 5 to achieve ascending and descending functions. If the stuff layer 6 is a hard layer, like a palm chip layer or the like, the palm chip layer is divided into A1 section, B1 section, C1 section, D1 section and E1 section according to the shape of the multi-section bed board 5. The A1 section is adhered to the A section, the B1 section is adhered to the B section, the C1 section is adhered to the C section, the D1 section is adhered to the D section, and the E1 section is adhered to the E section to achieve ascending and descending functions.

The mattress frame 4 has four legs to provide a space between the mattress frame 4 and the ground for mounting the transmission shaft and so on. For heightening the height of the mattress, the mattress frame 4 is further provided with four detachable support legs 13. The four detachable support legs 13 are respectively provided with bolts for threadedly connecting the legs of the mattress frame 4. The outer side of the mattress frame 4 is provided with a wooden frame 12.

The smart mattress of the present invention is like a normal mattress when the lift device and the massage device are not used and hidden in the mattress. When in use, the user can elect the button of the wireless control device 10 according to the demand. When the massage function is required, the user can elect the shoulder and neck massage button, the waist massage button or the leg massage button (disposed on the wireless control device 10, not shown in the drawings) of the wireless control device 10. The wireless control device 10 issues a command to the control box 2, and the control box 2 instructs the corresponding massage unit to work. When the lift function is required, the user can elect the head lift button, the leg lift button or both the head lift button and the leg lift button (disposed on the wireless control device 10, not shown in the drawings) of the wireless control device 10. The wireless control device 10 issues a command to the control box 2. After receiving the command, the control box 2 instructs the corresponding electric linear driver 3 to work and generate a linear thrust to push the swing arm 15 on the transmission shaft 14 through the push block (not shown in the drawings). The swing arm converts the thrust into torsion to supply to the support arm 16. The support arm 16 sends the angular momentum to the corresponding action end of the multi-section bed board 5. All the A section, B section, D section and E section of the multi-section bed board 5 can ascend and descend to achieve comfortable memory setting.

The lift function and massage function of the smart mattress of the present invention can be used separately or together.

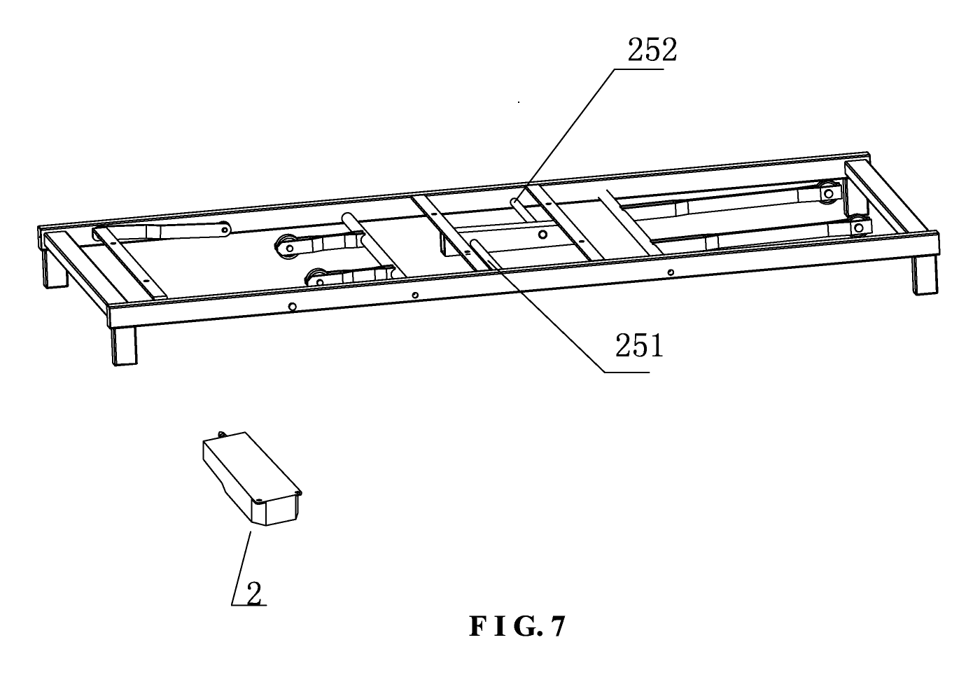

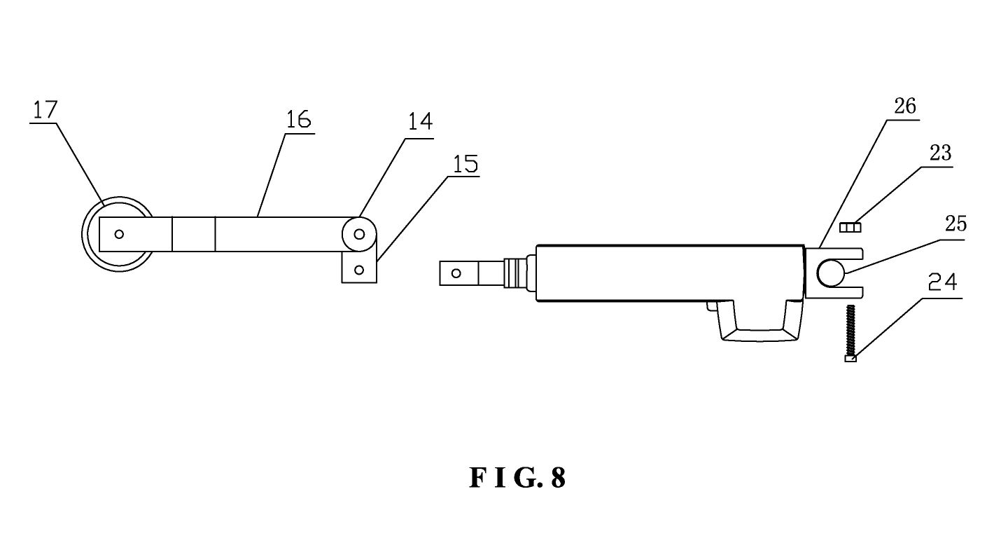

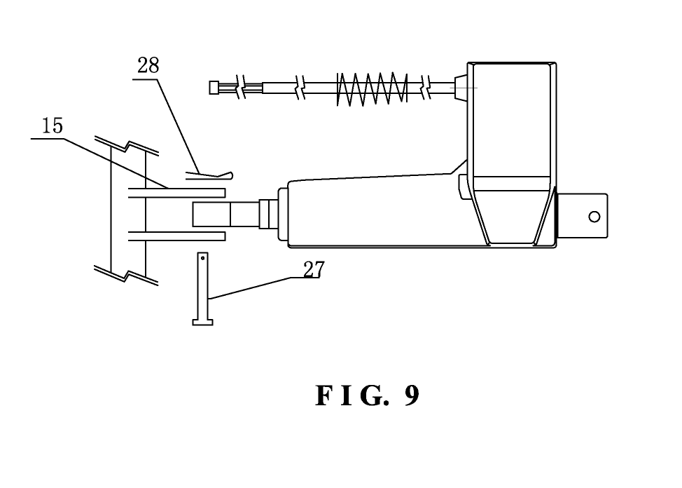

As shown in FIG. 7 to FIG. 9, the smart mattress of the present invention provides an ultra-thin effect. The control box 2 and the two electric linear drivers 3 of the smart mattress of the present invention can be separately installed. The middle portion of the mattress frame 4 is provided with a head driver fixing shaft 251 and a leg driver fixing shaft 252. The tail of the electric linear driver 3 is engaged on a driver fixing shaft 25 and fixed with a nut 23 and a screw 24. The head of the electric linear driver 3 has a through hole. A pin 27 is provided to insert through the through hole of the head of the electric linear driver 3 and the through hole of the swing arm 15 and locked with a lock member (28). The control box 2 is fixedly installed underneath the E section of the multi-section bed board 5.

The present invention combines the mattress lift adjustment function, the massage function and the sleeping function together, having the physiotherapy function of the massage bed to overcome the shortcoming of the conventional massage bed with a single function. When the massage function is not required, the massage device is hidden in the bed to be used as a normal bed. Compared to the soft electric lift bed and cushion, the mattress is lifted to provide a support to the spine when the user reads a book or watches TV. The height of the mattress is selective to mate with a Chinese bed frame or a European bed frame by replacing the mattress to achieve the aforesaid functions to avoid secondary waste. The present invention provides an ultra-thin smart mattress. This is a breakthrough development.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A smart mattress, comprising a mattress base, a bed assembly, a massage module and a wireless control system, the mattress base comprising a mattress frame, the bed assembly being mounted on the mattress frame, the bed assembly comprising a multi-section bed board, a stuff layer and a latex layer from bottom to top, the bed assembly and the mattress base being wrapped with a knitted fabric, the massage module being embedded in a bottom of the stuffer layer and connected with corresponding function interfaces of the wireless control system.

2. The smart mattress as claimed in claim 1, wherein the massage module comprising a shoulder and neck rolling massage unit, a waist rolling massage unit and a leg vibration massage unit.

3. The smart mattress as claimed in claim 1, wherein the mattress frame comprises a transmission shaft therein, two ends of the transmission shaft are movably connected with the mattress frame, a middle portion of the transmission shaft is fixedly connected with a support arm, a distal end of the support arm is connected with a pulley, when in motion, the pulley contacts the multi-section bed board, the wireless control system comprises a wireless control device and an electric linear driving device controlled by the wireless control device, the electric linear driving device is inserted on the transmission shaft through transmission shaft engaging troughs formed at two ends of the electric linear driving device, the electric linear driving device comprises an electric linear driver, the electric linear driver comprises a push block therein, the transmission shaft is connected with a swing arm, and the swing arm is contact with the push block.

4. The smart mattress as claimed in claim 3, wherein the transmission shaft comprises a head transmission shaft and a leg transmission shaft, the head transmission shaft and the leg transmission shaft are parallel to each other.

5. The smart mattress as claimed in claim 4, wherein the multi-section bed board is a wooden board comprising A section, B section, C section, D section and E section which are hingedly connected with one another, two parallel first iron plates are provided between the head transmission shaft and the leg transmission shaft, two ends of each first iron plate are fixed to the mattress frame, each first iron plate has two connecting holes for connection of the C section of the multi-section bed board, a tail portion of the mattress frame is provided with a second iron plate which is parallel to the first iron plates, a pair of third iron plates is provided in front of the second iron plate, one end of each third iron plate is fixed to the mattress frame with a screw, a gap is formed among each third iron plate, the screw and the mattress frame, two ends of the second iron plate are respectively connected with the pair of third iron plates, and the second iron plate has two connecting holes for connection of the E section of the multi-section bed board.

6. The smart mattress as claimed in claim 3, wherein the electric linear driving device further comprises a control box, the massage module is connected with corresponding interfaces on the control box, and the electric linear driver is connected with the corresponding interfaces on the control box.

7. The smart mattress as claimed in claim 1, wherein the stuff layer is one of a spring chip layer, a palm chip layer and a sponge chip layer or a combination thereof.

8. The smart mattress as claimed in one of claims 1 to 7, wherein the mattress frame has four legs at a lower end thereof, and an outer side of the mattress frame is provided with a wooden frame.

9. The smart mattress as claimed in claim 8, wherein the mattress base is further provided with four detachable support legs, the four detachable support legs are respectively provided with bolts for threadedly connecting the legs of the mattress frame.

10. The smart mattress as claimed in one of claims 1 to 7, wherein the control box and two electric linear drivers are separately installed, a middle portion of the mattress frame is provided with a head driver fixing shaft and a leg driver fixing shaft, a tail portion of each electric linear driver is engaged on a driver fixing shaft and fixed with a nut and a screw, a head of each electric linear driver has a through hole, a pin is provided to insert through the through hole of the head of each electric linear driver and the through hole of the swing arm and locked with a lock member, and the control box is fixedly installed underneath the E section of the multi-section bed board.
